(19) United States
(12) Patent Application Publication
(10) Pub. No.: US 2014/0038697 A1
(43) Pub. Date: Feb. 6, 2014

(54) METHOD AND APPARATUS FOR ONLINE GAMING AND COMMERCE USING A SOCIAL NETWORK

(71) Applicants: Piyush Bansidhar SHAH, Los Gatos, CA (US); Philipp Michael STAUFFER, Palo Alto, CA (US)

(72) Inventors: Piyush Bansidhar SHAH, Los Gatos, CA (US); Philipp Michael STAUFFER, Palo Alto, CA (US)

(73) Assignee: ZALZERO INC., Palo Alto, CA (US)

(21) Appl. No.: 13/565,042

(22) Filed: Aug. 2, 2012

(51) Int. Cl. G07F 17/32

(52) U.S. Cl. CPC G07F 17/3272
USPC 463/25; 463/42

(57) ABSTRACT

A computerized method that includes receiving from a first user over a network a prize selection choice and an interaction mode launch request. The method also includes receiving from the first user over the network an invitation for at least one additional user to form a social network for participating in the interaction mode, and then launching the interaction mode for at least the first user and the one additional user. A prize is awarded to at least one of the users of the interaction mode.

### FIELD OF THE INVENTION

This invention relates generally to the field of computerized social networks, online gaming and commerce.

### BACKGROUND

There are a variety of types of online games available today. Users are becoming accustomed to social gaming online, but users typically become bored with playing the same games relatively quickly. Users have also become accustomed to various forms of online shopping and e-commerce.

Marketers of goods and products seek to drive brand awareness and sales through various platforms, including online advertising. Traditional online advertising has benefits and limits. In connection with online gaming, one traditional way for a marketer to advertise is to use custom-built promotions and/or applications. Such promotions can be expensive in both development and marketing/operations and can have limited effectiveness with prospects and consumers.

As online gaming expands, developers of games seek to build awareness and recognition of developed games. It can, however, be difficult for game developers to monetize their games. For instance, if an online game is not in the top twenty or so online games, monetization opportunities can be limited.

A need, therefore, exists for a more flexible online gaming platform that is of interest to users and that benefits marketers and developers of games.

### SUMMARY OF INVENTION

According to one embodiment, the invention is a computerized method that includes receiving from a first user over a network a prize selection choice and an interaction mode launch request. In this embodiment, the invention can relate to a method of online gaming (i.e., one type of interaction mode) that uses a social network or any other method of connecting to participating users. The method also includes receiving from the first user over the network an invitation for at least one additional user to form a social network for participating in the interaction mode, and then launching the interaction mode for at least the first user and the one additional user. A prize is awarded to one of the users of the interaction mode. The social network can be formed by the first user, the additional user, and any number of additional users who participate in the interaction mode. The invention can also include a non-transitory computer readable medium containing instructions that, when executed, perform the steps described above.

An “interaction mode” can be anything where multiple users engage with each other to achieve an outcome. For example, one type of interaction mode can be an online game where users compete with one another to attempt to win the game. For example, the prize can be awarded to the winner of the online game. Another type of interaction mode can be an interactive online experience where users jointly participate to achieve an outcome. There can be a variety of types of interaction modes that fall within the scope of the invention.

The method and system described above can be used by marketers of goods or services to market such products. For example, a marketer can sponsor one or more prizes to allow users to participate in an interaction mode at no expense to the user. The marketer can build goodwill and product recognition through the system by, in part, providing prizes that are awarded to at least one participant in an interaction mode.

Another embodiment of the invention can be a computerized method for forming an online interaction mode. This method can allow a marketer to develop a customized website or other type of digital experience for the user in online gaming or the like for the promotion of products. This method can include providing a user interface over a network, where the computer interface allows for interaction with a marketer of a good or service. The user interface can be used for receiving at least one prize selection choice from the marketer over the network, receiving at least one interaction mode selection choice from the marketer over the network, receiving at least one parameter relating to the interaction mode from the marketer over the network, and receiving marketing options from the marketer over the network. The information set forth above can be used to develop an interactive website or user experience for the marketer.

### BRIEF DESCRIPTION OF THE DRAWINGS

The invention is illustrated in the figures of the accompanying drawings which are meant to be exemplary and not limiting, in which like references are intended to refer to like or corresponding part, and in which:

FIG. 1 is a block diagram of a system in which the invention can be practiced;

FIG. 2 is a flow diagram of a method that can be used according to an embodiment of the disclosed subject matter;

FIG. 3 is a block diagram of the structure of the social network and interaction mode system according to the embodiments of FIG. 1 or 2;

FIG. 4A is a flow diagram showing greater detail of the pre-game experience of the method and system shown in FIGS. 1-3;

FIG. 4B is a flow diagram showing greater detail of a second pre-game experience of the method and system shown in FIGS. 1-3;

FIG. 4C is a flow diagram showing ways in which prizes can be selected according to the embodiments of in FIGS. 1-4B;

FIG. 5 is a flow diagram showing greater detail of the game experience of the method and system shown in FIGS. 1-3;

FIG. 6 is a flow diagram showing greater detail of the post-game experience of the method and system shown in FIGS. 1-3; and

FIG. 7 is a flow diagram of a computerized method for forming an online interaction mode for a marketer of a product or service according to an embodiment of the invention.

### DETAILED DESCRIPTION

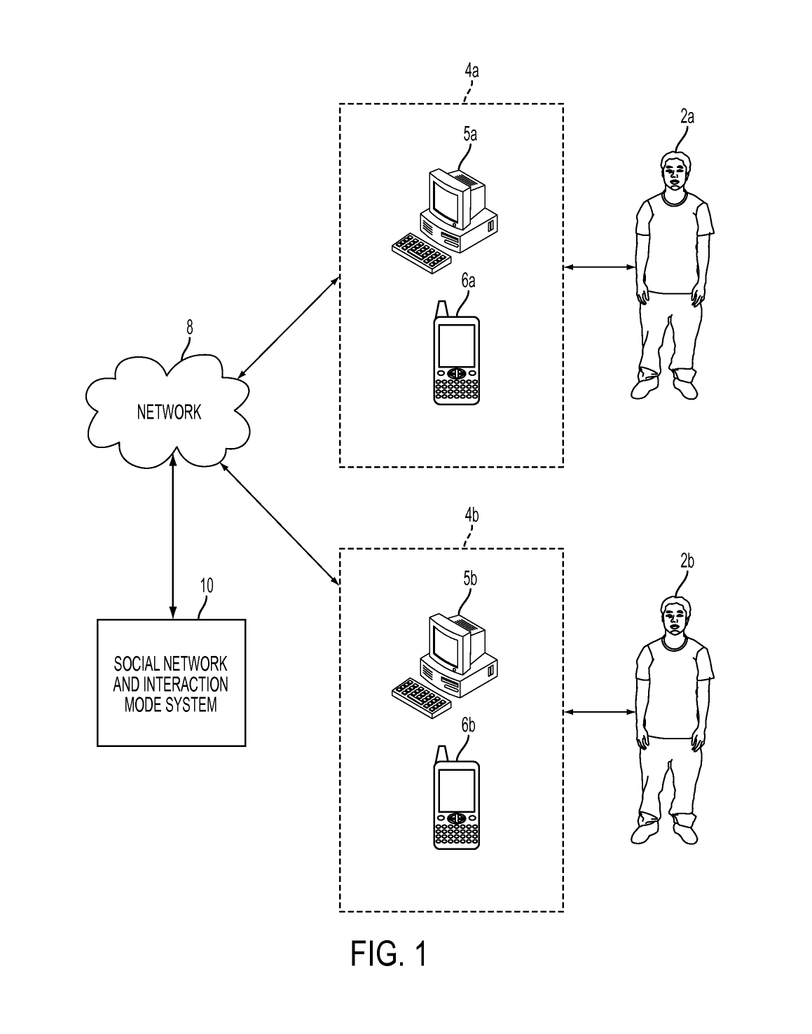

To address the need set forth above, according to one aspect, the invention relates to a social network and interaction mode system and method. FIG. 1 shows one embodiment of a system in which the invention can be practiced. FIG. 1 includes two users 2a, 2b. These users 2a, 2b may also be referred to as players or participants. During operation, each user 2a, 2b uses a computing device 4a, 4b to communicate though a network 8 with a social network and interaction mode system 10. FIG. 1 shows two users 2a, 2b, but a larger number of users can be used.

The computing devices 4a, 4b can each be a personal computer or a wireless mobile device, such as a smart phone or tablet. In short, any type of device that allows interaction with the network 8 can be used for the computing devices 4a, 4b. FIG. 1, for instance, shows the possibility of user 2a using a personal computer 5a or a wireless mobile device 6a for the computing device 4a. Similarly, FIG. 1 shows user 2b using a personal computer 5b or a wireless mobile device 6b for the computing device 4b. The personal computer 5a, 5b can be any type of computer used by consumers, such as a desktop or a laptop computer. In addition, the wireless mobile device 6a, 6b can be any type of wireless device used by consumers, including smart phones or tablets. If a smart phone is used, the smart phone can be any type of smart phone known in the art, including, for example, an iPhone or an Android smart phone. In addition, if a tablet is used, the tablet can be any type of tablet known in the art, including, for example, an iPad, Android or Windows 8 tablet.

The network 8 can be any type of network, including, for instance, the World Wide Web or proprietary networks such as X-box live. The social network and interaction mode system 10 can be, for instance, one or more servers that are connected to the network 8 and that allow for interaction with the users 2a, 2b through the computing devices 4a, 4b.

The social network and interaction mode system 10 can include one or more memories (not shown), which can be any type of memory device known in the art. The memory can be, for example, a non-transitory computer readable medium that stores instructions. These instructions can be the code that performs the functions described above and below for the social network and interaction mode system. The instructions can include the logic/code for interaction with the computing devices 4a, 4b, but can also include logic/code that can be downloaded to the computing devices 4a, 4b to be run on the computing devices 4a, 4b. One or more processors (not shown) in the one or more servers of the social network and interaction mode system 10 can run the instructions to carry out the functions described herein. In addition, in other embodiments, one or more processors (not shown) in the one or more computing devices 4a, 4b can run instructions to carry out the functions described herein.

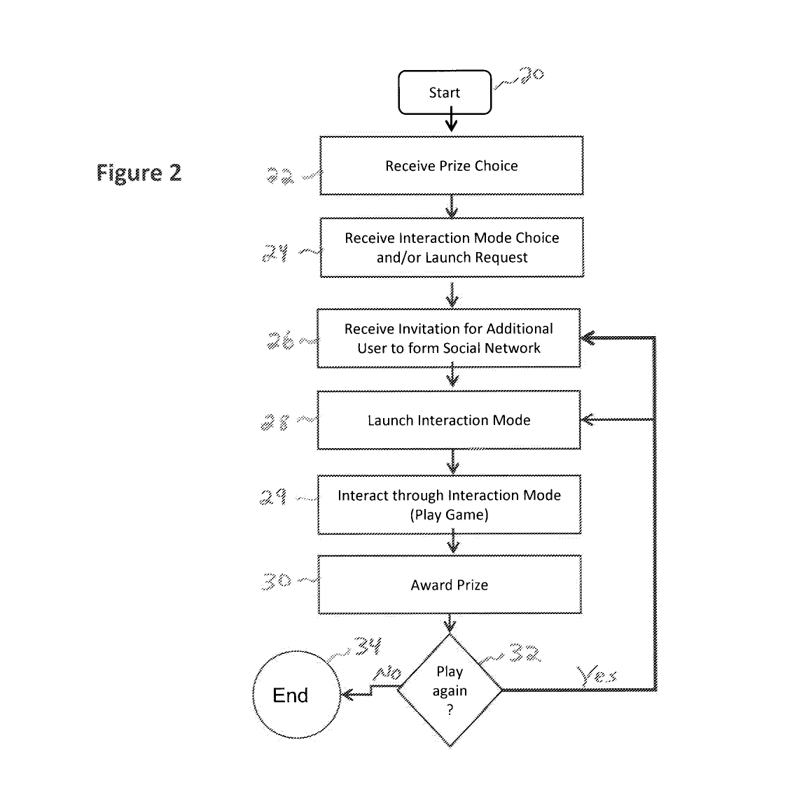

FIG. 2 shows a flow diagram according to one embodiment of the invention. In FIG. 2, after starting (block 20), the social network and interaction mode system 10 can receive from a first user over a network a prize selection choice and an interaction mode selection choice and/or a launch request. This is shown in blocks 22 and 24. The prize selection choice of block 22 can be in a variety of forms, including, for instance, a prize sponsored by a merchant or an unsponsored prize that requires an entrance fee/payment. After receiving the prize selection choice, the social network and interaction mode system 10 next receives from the first user over the network an invitation for at least one additional user to form a social network for participating in the interaction mode. This is shown in block 26 of FIG. 2. This allows the first user to form a social network to participate in the interaction mode. The invitations can be in a variety for forms, including as invitations suggested by the system 10 or as invitations received directly from the first user. Next, the system 10 launches the interaction mode for at least the first user and the one additional user. This is shown in block 28. When the interaction mode is launched, this allows the users to participate in the interaction mode until at least one round of interaction is completed, as shown in block 29. In some embodiments, the interaction mode can be launched for a social network of more than two users, such as any number of users greater than two. Next, at block 30, a prize is awarded to at least one of the users of the interaction mode. For example, the winner of a game can be awarded a key prize. In addition, other users/participants of the social network can be awarded rewards or participation prizes. Further, instead of merchant or marketer sponsoring a prize, individuals could donate items for a fixed price with all proceeds going to charity. The prize can either be played for “free,” “donated” through different mechanisms (i.e. a fixed price per ticket that will go to charity) or “fully paid.” After the prize is awarded, the system can query whether the network of users wishes to play the interaction mode again (block 32). If the answer is yes, the system reverts back to block 26 or 28 and the interaction mode is launched again. If the answer is no, the flow ends at block 34.

The system and method described above can be used by marketers of products to market particular products, to build up goodwill, or to drive potential customers to a store to claim awards/prizes. In addition, user interfaces and screens described herein can be branded with a marketer's advertising material to present a branded experience for the marketer. For example, a marketer can sponsor a variety of prize selections, in which case the game itself can also be branded with the marketer's advertising or brand materials. This allows a marketer to operate part of all of an online gaming experience to drive business outcomes such as additional sales. It also allows the marketer to gather analytical information about the effectiveness of various advertising campaigns based on interest in the marketer's products, the prizes awarded, and the redemption rate of prizes among others.

In one embodiment, the invention can relate to a method of online gaming that uses a social network. Throughout the discussion below, the term “game” may be used to refer to a type of interaction mode. Any descriptions of games below can also apply to other types of interaction modes. According to the embodiment of FIG. 2, a user can initiate a game at any time. The user can also invite additional users, such as friends, to participate in the game. In addition, a user can simply join a game that another user has already initiated and who is looking for additional players. There is no implication of a ‘single’ winner of a game, although there can be a single winner in some embodiments. Instead, the game (or interaction mode) is formed via a social network. Such a social network can be dynamic in that it is formed by users at a location or who just share a common interest in playing the game, or static in the sense that it is formed from existing social networks. The games used within the invention can be any variety of games (if the interaction mode is a game). One game, for instance, can be a “battleship” game where the user/player with the most points wins the game.

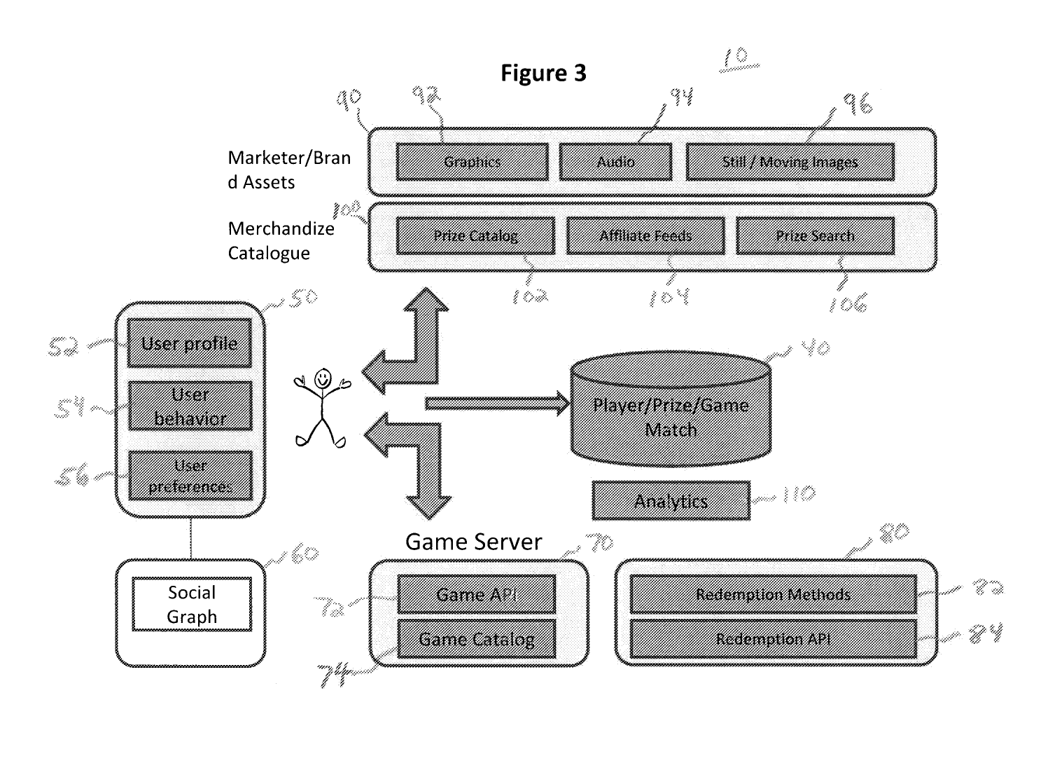

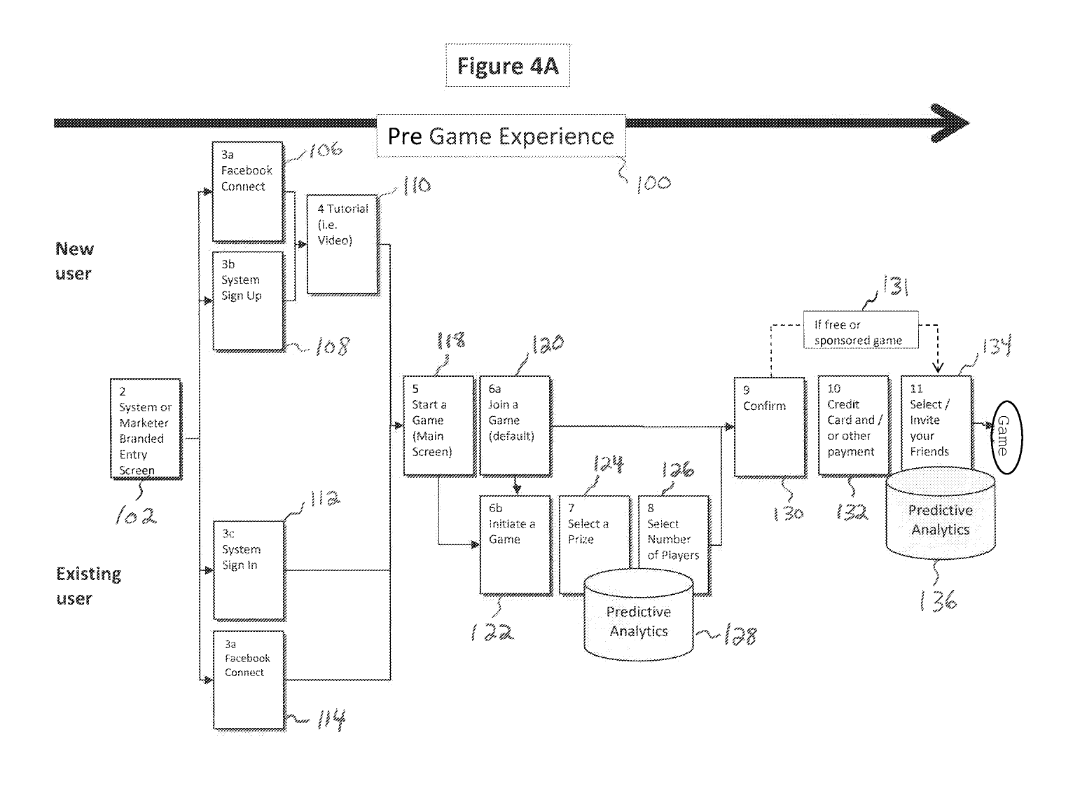

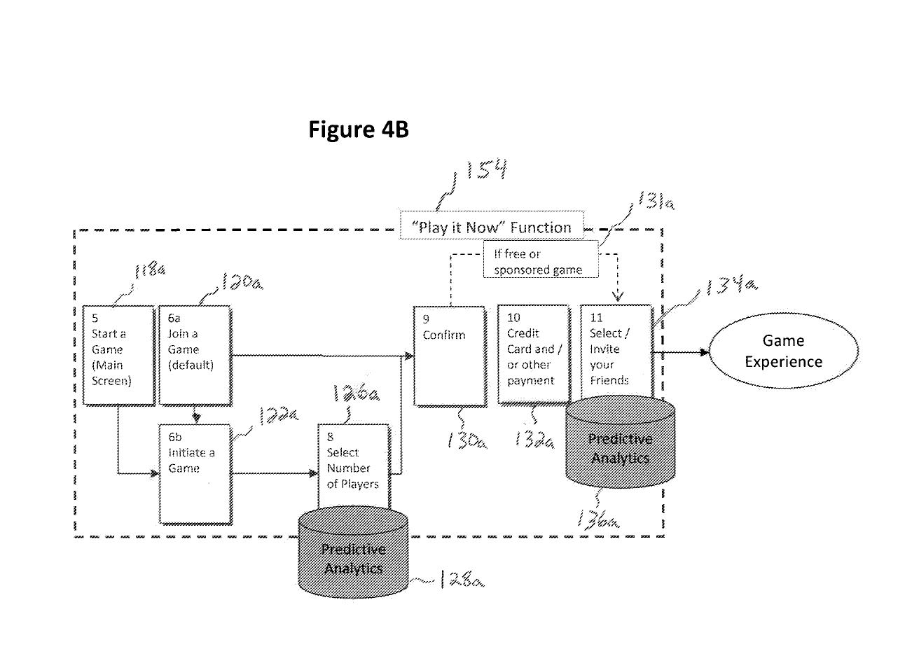

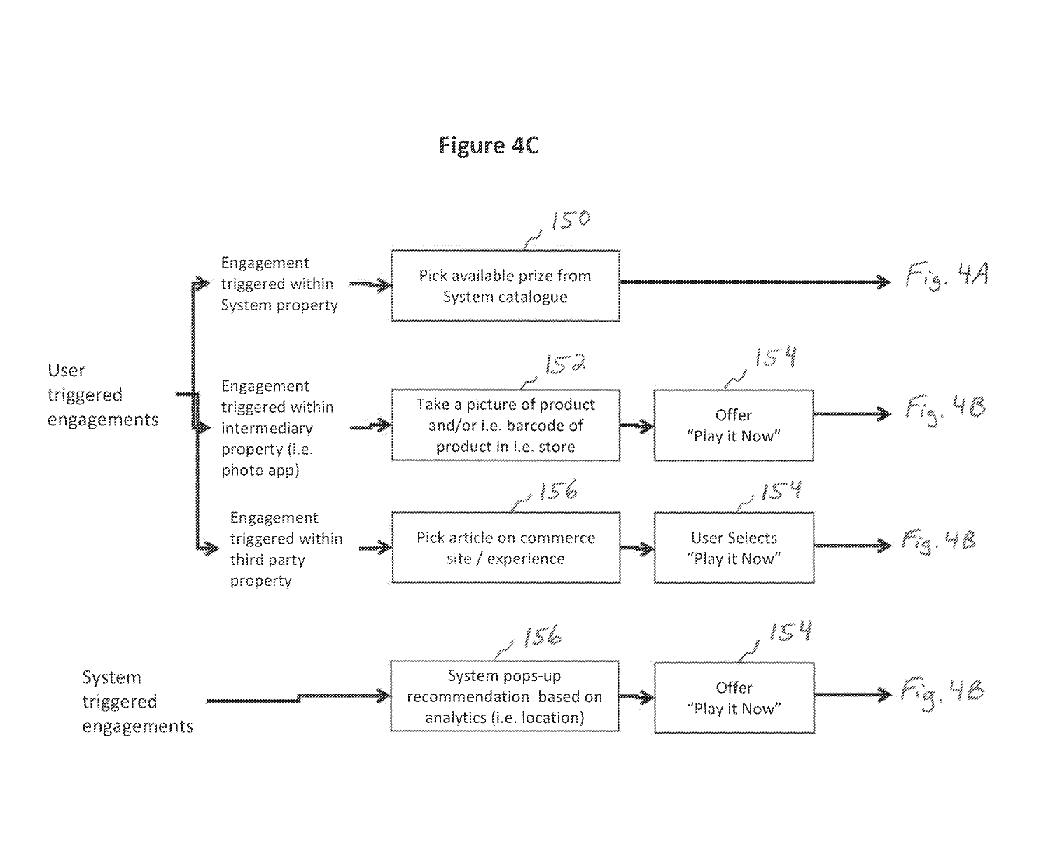

FIG. 3 is a block diagram of the structure of the social network and interaction mode system 10 (of FIG. 1) according to one embodiment of the invention. FIG. 3 shows that the system can include player/prize/game match logic and code 40, user information 50, social graph information 60, a game server 70, a redemption server 80, a database of marketer/brand assets 90, a merchandise catalog 100, and predictive analytics logic 110. These blocks can interact to perform the method described above in connection with FIG. 2. Each of these blocks is described in greater detail below. The logic/code and databases set forth in FIG. 3 and described below can exist at the server level in certain embodiments. One or more servers connected to, for example, the web, can host the logic/code and databases described herein. Additional features of the blocks of FIG. 3 are also described below in connection with FIGS. 4-6.

The player/prize/game match logic and code 40 is the engine that runs the logic/instructions to perform the method described above. For instance, the player/prize/game match logic and code 40 can be a server with code that interacts with a set of databases and users to carry out the method and system described herein. This code 40 can include, for instance, logic to interact with various users (i.e., players in some embodiments), including helping users invite one or more additional users to participate in a game or receiving instructions for participating in a game. This code 40 can also help users select games/interaction modes and pricing for participation. In addition, this code 40 can help with awarding prizes to different users. In addition, this code 40 can also help manage multiple privacy policies across participating partners in order to guarantee compliance.

The user information 50 can include a database of user profiles 52, a database of user behavior 54, and user preferences 56. The database of user profiles 52 can include, for instance, profile information for users registered with the system. This information can include name, email address, city, state, and payment information (i.e., credit card information or the like) in some embodiments. Other user information can also be collected. The user behavior database 54 can store information about each user's participation in the system, including the interaction modes for which each user has participated, the prize or prizes awarded to that user, and other information relating to the user's interaction with the system. The user preferences 56 can include a variety of preferences of the user, including preferences of user interfaces generated by the system for display at the user's computing device (see device 4a, 4b of FIG. 1).

The social graph information 60 can include information relating to various social networks formed according to the invention. For example, if one user invites three other users to participate in a game for a prize, the social graph database 60 can store information about this potential network of four users. If the four users actually do participate together in an interaction mode, the database 60 can store this information. The social graph information 60 can also be used to generate suggestions for a given user about which other users to invite for participation in a social network for an online game. Such a suggestion, for instance, can be based on past behavior of the users, predicated behavior of the users, or on profile information about the users. Social graph information 60 is typically a combination of data pulled from third parties (such as facebook) and proprietary system data generated through the interaction of users in the system. Both user information 50 and social graph information 60 allow to accommodate and manage multiple privacy policies associated with partners such as marketers in order to allow for privacy policy compliance.

The game server 70 can include a game application programming interface (API) 72 and a game catalog 74. The game API 72 can be used by the code 40 to provide a user interface to the user's device (device 4a, 4b of FIG. 1) to allow the user to choose a game for participation. The game API 72 can also be used to launch a game after selection by the user. The game catalog 74 can include a database of various games (or interaction modes) for participation. In an online system, the game catalog 74 can include any type of game for user participation, including, for example, classic games such as chess or checkers or battleship, or any other type of game. The games can be, for example, games of skill, not purely games of luck.

The redemption server 80 can include a redemption API 84 and a redemption methods database 82. After participation in an interaction mode, for example, a prize can be awarded to one or more winners. The redemption server 80 can be used to help the winner(s) redeem prizes. For example, the redemption methods database 82 can include a variety of ways to redeem prizes, such as receiving a code for online purchases, a physical gift card, or an interface for sending address information for shipment of a prize. The redemption API 84 can be used to provide one or more user interfaces to the user for redemption purposes, as well as to allow for interaction with various experiences or methods for redeeming prizes.

The database of marketer/brand assets 90 can include a variety of information to allow marketers of goods or brands to promote their products or services through an integrated and customized brand experience. In some embodiments, the database of marketer/brand assets 90 can include graphics 92, audio 94, and still and moving images (such as video) 96. The graphics 92 can include logos, background graphics, objects and object templates to uncover or draw during the interaction mode as part of the game. Audio 94 can include brand specific and customized audio messages and tones that are played at certain times during interaction. Still and moving images 96 can include brand specific video sequences and/or images during interaction.

The merchandise catalog 100 can include a variety of information about various prizes of related information that can be used for the interaction modes. In some embodiments, the merchandise catalog 100 includes a prize catalog 102, an affiliate feeds database 104, and a prize search API 106. The prize catalog 102 can include a database of prizes for which users can compete in an interaction mode. The affiliate feeds 104 can include marketing information relating to these prizes and can include feeds directly from a marketer or other source relating to one or more prizes. The prize search API 106 can be used by a user to search for a prize for which the user may wish to make the subject of an interaction mode. The prize catalog can be generalized to support the search API as provided by, for example, Amazon.

The predictive analytics logic 110 can be used by the system to determine users to invite for an interaction mode using various information from the databases of FIG. 3, leverage proprietary and third party user data such as behavioral data, interest data, intent data, influencer scores (such as Klout score), monitor and predict future behavior of users, and for additional purposes. Collaboration interfaces like chat or location radar are provided to encourage ad-hoc social network formation based on location (i.e., coffee shop, airport), common interest (i.e., game type, prize type). Prizes and interests can be either explicitly derived from users touching products, photographing products, purchasing products, expressing likes or implicitly from predictive analytics like User or Item based collaborative filtering or social network activity analysis.

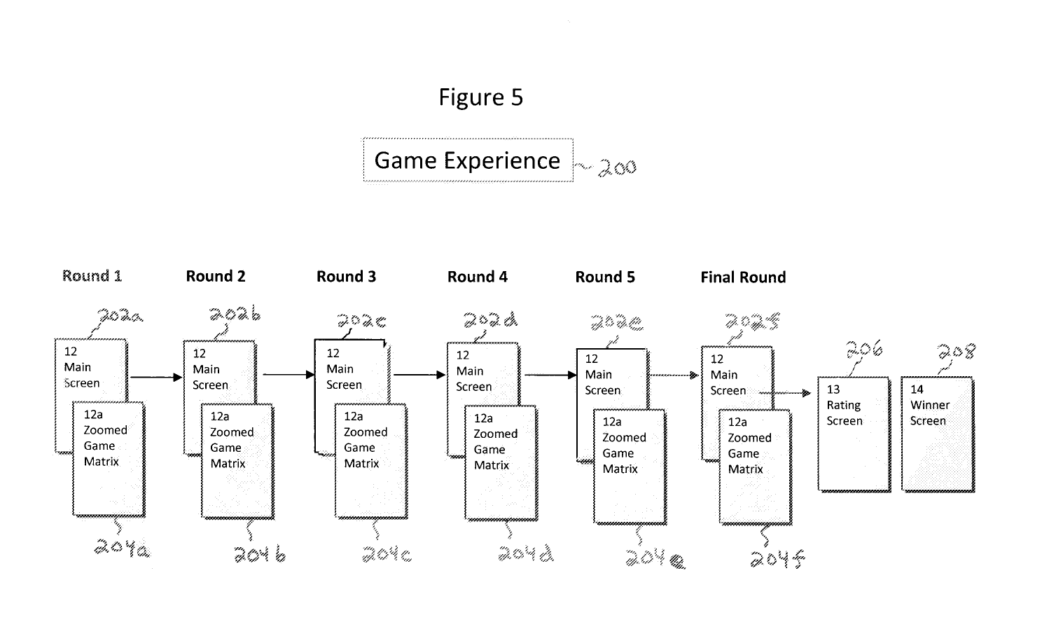

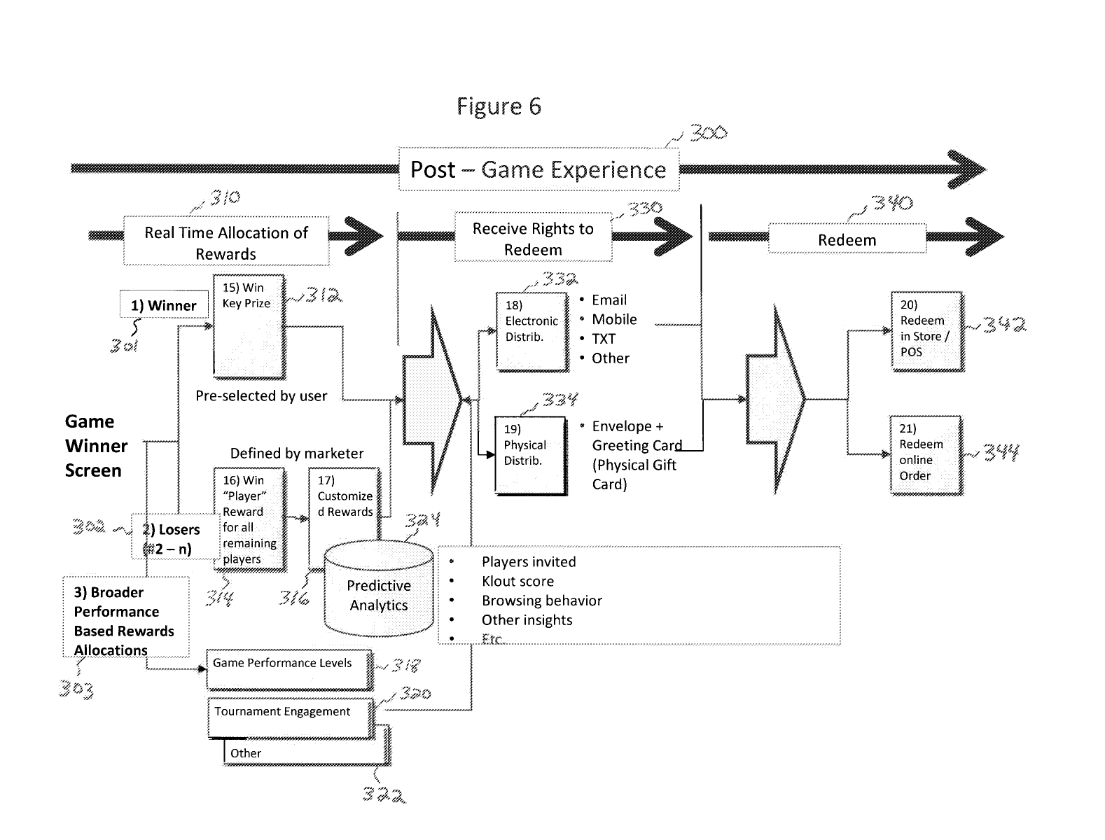

FIGS. 4-6 are flow diagrams showing greater detail of the method and system shown in FIGS. 1-3. FIGS. 4A-4C are flow diagrams showing greater detail of the pre-game experience 100 of the method and system shown in FIGS. 1-3. FIG. 5 shows the game experience, and FIG. 6 shows the post-game experience.

The flow diagram of FIG. 4A shows the experience largely from the standpoint of the user of device 4a, 4b (see FIG. 1). The flow diagram, however, also depicts how user interface screens or the like can be generated by the system (shown in 10 in FIG. 1), and the diagram also shows what information the system (i.e., the system 10 of FIG. 1) receives from the users. In FIG. 4A, block 102 depicts a system or marketer branded entry screen which is the first screen the user will interact with to sign in (existing user) or sign up (new user).

FIG. 4A shows that new users can use a different path from existing users at the beginning of the experience. New users can connect with the system through a variety of methods, including, for example, through facebook Connect, as shown in block 106. In addition, new users can sign up 108 through the system itself, as shown in block 108. Upon sign-up, new users can be required to enter a variety of information about themselves (i.e., name, email address, city, state, phone number, demographic information, etc . . . ). In some embodiments, the user may also be required to enter payment information and shipping address. The system can present a user interface to the user for entering sign-up information, and upon submission by the user, the system can store this information. After submission of sign-up information, a new user can optionally be shown a tutorial such as a video tutorial about how to use the system, as shown in block 110 of FIG. 4A. Users may also be prompted to share information for future interactions at Point-of-Sale (POS) systems. Examples include NFC systems that allow one-touch purchase.

Existing users can sign onto the system in a more streamlined fashion, as shown in blocks 112 and 114. The sign on interface for an existing user can be simpler, and can, for instance, involve the submission of the user's name and password (block 112). Sign on can also be achieved through other services such as facebook connect (block 114)

After sign-on, a main user interface screen can be presented to a user, as shown in block 118. This main user interface screen can include, for example, a choice to allow the user to begin a game. The main user interface screen can also allow a user to join a game that has already been initiated by another user, as shown in block 120. For instance, if another user has already selected a prize and launched a game, the current user can be allowed to join that game, whether it has already started or not. In embodiments in which the flow is branded by a marketer of a product or service, only specific games that hold the marketer's prizes are available for selection in block 120.

If a user wishes to initiate a new game, a user interface screen can be presented to the user for initiation of a new game, as shown at block 122. The user can be presented with one or more user interface screens for the selection of a game, a prize, and for selection of participants in the game. In block 122, a user interface screen can present a number of games for possible selection by the user. In embodiments in which the flow is branded by a marketer of a product or service, only specific games that hold the marketer's prizes are available for selection in block 122.

In block 124, the user can select a prize, and this prize selection choice can be received by the system. For example, a user interface can be presented to the user's device, where the user interface includes a plurality of prize selection choices (i.e., a cup of coffee, a latte, a coffee mug, etc . . . ). The variety of plurality of prizes is unlimited and can include any type and value level of product or service. In some embodiments, prior to providing the user interface, prize selection choices can be filtered to form the plurality of prize selection choices based on social network choices of the first user, previous interest expression of the first user, or explicit filters or choices of categories of products or services. Predictive analytics or other logic can be used to present prize selection choices to the user. This user interface can be either the same user interface used for the selection of a game or a different user interface. For instance, the user interface can include both the game selection choices and the prize selection choices. Upon submission of this interface by the user, the system can receive both the interaction mode launch request and the prize selection choice. In addition, at block 126, the user can select a number of players for the game. This selection can include the selection of at least one additional user. As shown in block 128, predictive analytics can be used to help the user select the number of additional users for participation. The user plus the at least one additional user form a social network for participation in the game. In this embodiment, the social network includes at least the first user (who initiated the game), the additional user, and (optionally) a flexible number of additional users. When invitations are sent, the method can include receiving from the first user over the network invitations for at least one of the flexible number of additional users.

Block 130 depicts a confirmation step, which can be optional. This confirmation step can include allowing the user to confirm its previous selections.

At block 131, it can be determined whether the interaction mode is free (or sponsored) or whether payment is required for the game. This can depend on the prize selected by the user. In some embodiments of the invention, a feature is presented to the user to allow the user to select an interaction mode that has been sponsored by a marketer of a good or service. For instance, a particular marketer of coffee may sponsor a game that gives the winner a coupon for a free cup of coffee or for a coffee mug. In this embodiment, at least one of the prize selection choices is sponsored by a marketer of a product or service. In such sponsored games, no payment information is required from the user, since there is no entrance fee for the game. In some embodiments, the prize selection choices can be presented as a fully integrated and branded experience by a marketer. For example, the prize selections for a coffee shop can include brand logos and mottos for that brand, such that the user interface can be branded by the marketer. In other embodiments, the same interaction modes (or games) can be provided for different marketers. For example, if two marketers have different prize selection choices and branded user interfaces, the same game choices can be available from each user interface. In other embodiments, the interactions modes can be different for different marketers—that is, the interaction mode is inconsistent among multiple marketers.

In other embodiments, the prize selected by the user relates to a good or service that has a set value and that requires payment by the participants/users of the interaction mode. For example, a prize could be a laptop computer with a value of $450. In order to participate in an interaction mode where the prize is this laptop computer, payment from the users may be required. The specific amount of payment from each user can depend on the total number of users. For example, if the laptop is worth $450 and 10 users end up participating in a game for the laptop, each user may pay approximately $45 to participate. Or, alternatively, the $450 laptop price can be increased by a margin so that the total price is $500, which, when divided by 10 users, ends up being about $50 per user to play. In this embodiment, as additional users sign up for the interaction mode, the participation cost (i.e., entrance fee) for each user decreases. The system can determine the entrance fee in real-time as additional users register for the interaction mode. In other embodiments, a portion of the prize value may be paid by a marketer of a product or service, while the rest of the prize value is paid for by the participants.

In one embodiment, for example, the prize selection choice can relate to a good or service, and launching the interaction mode for at least the first user and at least one additional user can include receiving a payment from the first user and the additional user for participation in the online game. In this embodiment, the system can calculate the payment price for participation in the game based on at least the number of participants/users of the interaction mode.

In embodiments where payment is required, block 132 of FIG. 4A shows the collection of credit card information or other payment information. In other embodiments, this payment information is collected in advance during sign-up (such as in blocks 108 or 112).

The next step of FIG. 4A is block 134, where the user can select/invite other users (or friends) to participate in the game. As shown in FIG. 4A, the predictive analytics of block 136 can be used to help the user select the additional users for participation. A user interface can be presented to the user to aid the user in selecting at least one additional user to form a social network for participation in the interaction mode. For example, suggestions can be provided to the first user and/or additional users for one or more additional users based on known interest in the prize selected by the first user, assumed interest in the prize selected by the first user, or based on known social networks. Furthermore, suggestions can be provided to the first user and/or additional users for one or more additional users based on ad-hoc networks such as airplane networks, coffee shop networks or other proprietary networks based on proximity, location or other factors. Thus, the system can help the user select one or more additional users for participation in the interaction mode.

In short, one or more user interfaces can be presented to the user for selection of a prize, an interaction mode, and one or more additional users for participation in the interaction mode. Upon selection, the system can receive such a prize selection choice, interaction mode launch request, and users for invitation for participation. The interaction mode launch request can be, for example, the selection of a particular game for participation.

FIG. 4B is a flow diagram showing greater detail of a second pre-game experience of the method and system shown in FIGS. 1-3. The primary difference between FIG. 4A and FIG. 4B is that block 124 from FIG. 4A is not present in FIG. 4B. Instead, in FIG. 4B, the prize selection choice can be made earlier, as will be described below in connection with FIG. 4C. In FIG. 4B, a main user interface screen can be presented to a user, as shown in block 118a. The main user interface screen can also allow a user to join a game that has already been initiated by another user, as shown in block 120a. For instance, if another user has already selected a prize and launched a game, the current user can be allowed to join that game, whether it has already started or not.

If a user wishes to initiate a new game, a user interface screen can be presented to the user for initiation of a new game, as shown at block 122a. The user can be presented with one or more user interface screens for the selection of a game and for selection of participants in the game. In block 122a, a user interface screen can present a number of games for possible selection by the user. In embodiments in which the flow is branded by a marketer of a product or service, only specific games that hold the marketer's prizes are available for selection in block 122a.

Next, at block 126a, the user can select a number of players for the game. This selection can include the selection of at least one additional user. As shown in block 128a, predictive analytics can be used to help the user select the number of additional users for participation. The user plus the at least one additional user form a social network for participation in the game. In this embodiment, the social network includes at least the first user (who initiated the game), the additional user, and (optionally) a flexible number of additional users. When invitations are sent, the method can include receiving from the first user over the network invitations for at least one of the flexible number of additional users.

Block 130a depicts a confirmation step, which can be optional. This confirmation step can include allowing the user to confirm its previous selections. At block 131a, it can be determined whether the interaction mode is free (or sponsored) or whether payment is required for the game, which can be done in the same manner as described above in connection with FIG. 4A. In embodiments where payment is required, block 132a of FIG. 4B shows the collection of credit card information or other payment information. In other embodiments, this payment information is collected in advance during sign-up.

The next step of FIG. 4B is block 134a, where the user can select/invite other users (or friends) to participate in the game. The predictive analytics of block 136a can be used to help the user select the additional users for participation. Steps 134a and 136a can be done in a manner similar to that set forth above in connection with FIG. 4A.

FIG. 4C is a flow diagram showing ways in which prizes can be selected according to the embodiments of in FIGS. 1-4B. According to some embodiments, multiple ways to select a prize are possible for the user as FIG. 4C shows. The overall engagement can either be triggered by the user or by the system through a recommendation to the user. User triggered engagements can be that the user picks an available prize from the system's available catalogue in block 150 (as described above). If block 150 is selected by the user, it can be done in place of block 124 of FIG. 4A. In other words, step 150 can be used in conjunction with the flow of FIG. 4A. User triggered engagements can also be that the user takes a picture of a product or barcode through one of the network connected devices such as an iPhone in block 152. After taking a picture of a product the system would offer to play a game in block 154 declaring that particular product as the main prize and leading to the launch of the interaction mode in the manner shown in FIG. 4B. That is, if path 152 is used, the flow proceeds to block 118a of FIG. 4B. Another user triggered engagement can be launched through a link to the system provided on any digital experience for direction to a gaming platform, wherein the gaming platform interacts with code to perform one or more of the steps above. This is shown in block 156. For instance, a link can be placed on Amazon.com to allow a user of Amazon to participate in an interaction mode. The selection of the link by the user can take the user to a participation screen, such as that described above in connection with block 118a of FIG. 4B. A system triggered engagement also can be provided through analytics where the system described above would recommend to a particular user to play a game for a particular prize with for example particular friends. This is shown in block 156. If the path of block 156 is followed, block 154 offers the user the choice to play a game, and if selected, a link can take the user to a participation screen, such as that described above in connection with block 118a of FIG. 4B. Block 154 is a “Play it Now” function, and this function is also shown as block 154 in FIG. 4B. This “Play it Now” function allows for several ways for prize selection that quickly leads to an interaction mode experience. In any of these scenarios analytics can help determine what interaction mode and which players are most likely to engage at particular time and place. The player can always manually drive the selection of players as well.

FIG. 4C shows, for example, a number of ways in which a user can initiate an interaction mode. It depicts, in other words, a discovery mode for choosing a prize and/or helping the user decide to initiate an interaction mode. FIGS. 4A and 4B show steps that can be used to form a group for participation in an interaction mode. For example, blocks 126, 126a, 134, and 134a depict steps relating to selecting a number of users and inviting friends to participate in an interaction mode (i.e., forming a social network or group for participation in an interaction mode). FIG. 5 below shows the interaction mode/game experience.

FIG. 5 is a flow diagram showing greater detail of the game experience 200 of the method and system shown in FIGS. 1-3. The flow of FIG. 5 can follow from the flow of FIGS. 4A-4C. As shown in FIG. 5, in some embodiments, a game can involve various “rounds” of participation. In other embodiments, only one round can be used. FIG. 5 depicts an embodiment in which 6 rounds of participation are used. Analytics can be used to continuously optimize for length of game (number of rounds) and excitement of the game (participation) so that desired business metrics can be met. Data used to optimize the experience can be number of users participating in the game, season, time of day, type of game or interaction mode, interest and preferences of users and/or marketer/brand objectives, among many others. Each round can include presentation of a main screen that shows the overall game environment as well as the cockpit functions (blocks 202a-202f) and presentation of a zoomed game matrix screen that only shows the game environment and its essentials (blocks 204a-204f). After participation in the rounds, a rating screen can be presented that allows the user to rate the game and/or its users in block 206. Block 208 depicts a winner screen in which the winner and/or the whole ranking of players of the interaction mode can be shown.

FIG. 6 is a flow diagram showing greater detail of the post-game experience 300 of the method and system shown in FIGS. 1-3. The flow of FIG. 6 can follow from the flow of FIG. 5. FIG. 6 depicts three general steps relating to the post game experience: real time allocation of rewards (block 310), reception of rights to redeem (block 330), and redemption (block 340). The real time allocation of rewards (block 310) can include allocating prizes or rewards to one or more of the winners of the interaction mode (block 301), to one or more of the losers of the interaction mode (block 302), and/or to some broader performance-based set of the participants (block 303). As an example, block 301 can involve allocating the key prize that had been pre-selected by the user (see previous descriptions about the prize selection) to the winner of the game (block 312). For example, if the prize selected was a cup of coffee or a laptop computer, block 312 can allocate this key prize to the winner of the interaction mode. This award of the prize to one of the users can be based on performance during the interaction mode. In other embodiments, the prize can be awarded to multiple users. The length of a game or the rounds of the game can also be chosen based on performance of a user. For instance, a user who is playing very well may have his/her game end earlier than for users who are not playing as well.

In some embodiments, the key prize can be allocated to the winner of the interaction mode, and at least some of the non-winners (i.e., the losers) can also be allocated rewards. These rewards can be of less value than the key prize, but can still reward the user for participation in a game. For example, if eight users participate in an interaction mode for a key prize of a cup of coffee, the marketer of the coffee may provide the key prize to the winner, as well as 25% off a cup of coffee to the rest of the users or to some subset of the users (such as the next three finishers after the winner). This allows the marketer of the good or service to build up goodwill by providing some benefit to at least some of the non-winners of the interaction mode. Block 314 depicts the possibility that all the remaining players aside from the winner will get some participation reward. Block 316 allows for the customization of rewards based on various analytics (block 324). These analytics can be based on predictions of future participation, predictions about the expected value of a potential customer to the marketer, or based on a user's past interactions with the marketer. The analytics can leverage proprietary and third party user data such as behavioral data, interest data, intent data, influencer scores (such as Klout score), leverage, monitor and predict behavior of users, and can be used for inviting players for participation in future games.

Block 303 depicts the possibility of a broader set of performance based rewards to participants. These performance based rewards can be based on game performance levels (block 318), tournament engagement (block 320), or based on other metrics of participation by each user.

Block 330 of FIG. 6 depicts receiving rights to redeem after the allocation of rewards. In short, redemption rights can be based on electronic distribution (block 332) or based on physical distribution (block 334). Electronic distribution can include, for example, a coupon or promotion code via email, mobile messaging, text message, or via some other electronic method. Physical distribution can involve putting a greeting or gift card, or physical gift, in an envelop or box and sending it to the user.

The redemption (block 340) can involve the user redeeming the prize in the store or the point of sale (block 342) or redeeming the prize online (344).

In some embodiments, the system can create scarcity by performing one or more of a number of steps. The creation of scarcity can make it more desirable for certain users to participate in the interaction modes. For example, the system can create scarcity by performing at least one of limiting an available number of prizes, limiting a number of marketers for goods or services that sponsor a prize, limiting a number of interaction mode participations that any user can participate in over a selected period of time, limiting a number of participants in an interaction mode to enhance chances of winning a prize, and automatically calculating participation costs for each participant.

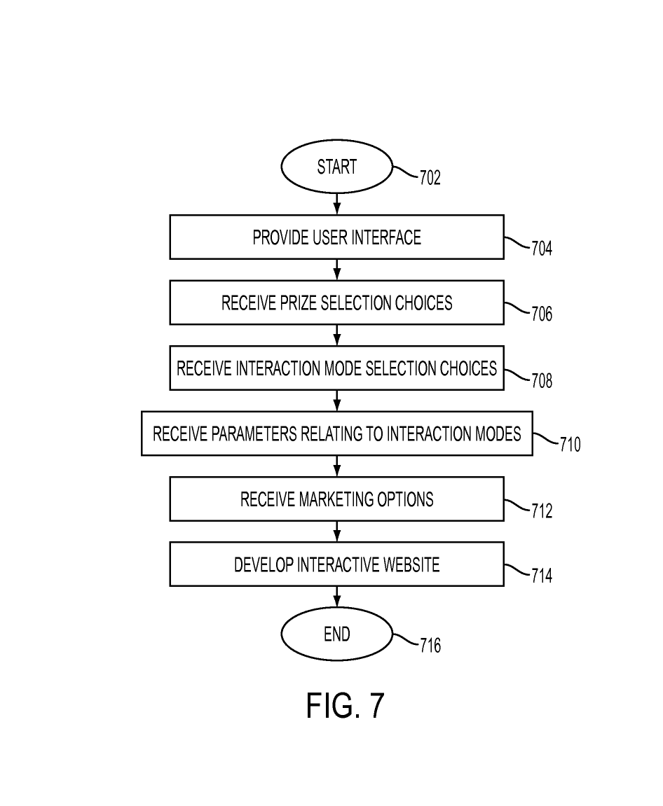

According to another embodiment, the invention can include a computerized method for forming an online interaction mode. This embodiment can be used by the marketer of a product or service to develop a platform to allow sponsored interaction modes that brand/market the marketer's products or services. This embodiment is shown, for example, in FIG. 7. In block 702, the method begins. Block 704 is the step of providing a user interface over a network, where the computer interface allows for interaction with a marketer of a good or service. Block 706 is receiving at least one prize selection choice from the marketer over the network. This step, for instance, can allow the marketer to provide one or more prizes for selection by users as set forth above. A marketer, for instance, may wish to provide a free cup of coffee, 50% of multiple cups of coffee, or free coffee cups. Block 708 is a step of receiving at least one interaction mode selection choice from the marketer over the network. This allows the marketer to select, for example, one or more games that the marketer may wish to be available for selection by users as described above. Block 710 is a step of receiving at least one parameter relating to the interaction mode from the marketer over the network. The parameters can relate, for example, to the number or prizes available in each category (i.e., free cups of coffee or coffee mugs, or coupons for 50% off cups of coffee), the number of participants that will be allowed in each game, the length of time over which prizes will be available, and other parameters. Block 712 is the step of receiving marketing options from the marketer over the network. The marketing options can include the selection of themes that the marketer may wish to use for the website or other user experience, such as skins that brand the experience according to the marketer's desire. Block 714 is the step of developing an interactive website or experience for the marketer using the information from the steps described above. The interactive website or experience can have, for example, the features described above in connection with any of the figures.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

We claim:

1. A computerized method for allowing users to enter an interaction mode, comprising:
(a) presenting to a first user over a network a user interface for selection of an interaction mode launch request from among a plurality of options;
(b) in response to receipt of the interaction mode launch request from the first user, presenting to the first user over the network a user interface for selection by the first user of an invitation for at least one additional user to form a social network for participating in the interaction mode, and receiving the invitation from the first user;
(c) presenting a user interface to the first user or the at least one additional user over the network for selection of a prize selection choice, wherein at least one of the prize selection choices is sponsored by a marketer of a product or service and is presented as a fully integrated and branded experience by the marketer;
(d) launching the interaction mode for at least the first user and the one additional user;
(e) awarding the prize to one of the users of the interaction mode; and
(f) storing information about each user's participation in one or more of the interaction modes.

2. The computerized method of claim 1, further comprising suggesting to the first user the at least one additional user based on known interest in the prize selected by the first user.

3. The computerized method of claim 1, further comprising suggesting to the first user the at least one additional user based on assumed interest in the prize selected by the first user.

4. The computerized method of claim 1, further comprising suggesting to the first user the at least one additional user based on known social networks.

5. The computerized method of claim 1, wherein the act of awarding the prize includes awarding the prize to multiple users of the interaction mode.

6. The computerized method of claim 1, wherein the interaction mode is an online game.

7. The computerized method of claim 6, wherein the prize is awarded to a winner of the online game.

8. The computerized method of claim 1,
wherein the user interface for the selection of a prize selection choice includes a plurality of prize selection choices.

9. The computerized method of claim 8, wherein the user interface includes a plurality of game choices for selection as the interaction mode launch request.

10. The computerized method of claim 9, further comprising:
prior to providing the user interface, filtering prize selection choices to form the plurality of prize selection choices based on social network choices of the first user, previous interest expression of the first user, or explicit filters or choices of categories of products or services.

11. (canceled)

12. (canceled)

13. The computerized method of claim 1, wherein the interaction mode is the same for multiple marketers.

14. The computerized method of claim 1, wherein the interaction mode is inconsistent among multiple marketers.

15. The computerized method of claim 1, wherein the prize selection choice relates to a product or service, and wherein launching the interaction mode for at least the first user and the one additional user includes receiving a payment from the first user and the additional user for participation in the online game.

16. The computerized method of claim 15, further comprising calculating a payment price for participation in the game based on at least the number of participants and price of the product or service.

17. The computerized method of claim 1, wherein the social network includes at least the first user, the additional user, and a flexible number of additional users, wherein the method further comprises receiving from the first user over the network invitations for at least one of the flexible number of additional users.

18. The computerized method of claim 1, further comprising creating scarcity by performing at least one of:
limiting an available number of prizes,
limiting a number of marketers for goods or services that sponsor a prize,
limiting a number of interaction mode participations that any user can participate in over a selected period of time,
limiting a number of participants in an interaction mode to enhance chances of winning a prize, and
automatically calculating participation costs for each participant.

19. The computerized method of claim 1, further comprising providing a link for direction to a gaming platform, wherein the gaming platform interacts with code to perform the steps of claim 1.

20. A non-transitory computer readable medium containing instructions that, when executed, allow a computer system to perform the following steps for allowing users to enter an interaction mode:
(a) presenting to a first user over a network a user interface for selection of an interaction mode launch request from among a plurality of options;
(b) in response to receipt of the interaction mode launch request from the first user, presenting to the first user over the network a user interface for selection by the first user of an invitation for at least one additional user to form a social network for participating in the interaction mode, and receiving the invitation from the first user;
(c) presenting a user interface to the first user or the at least one additional user over the network for selection of a prize selection choice, wherein at least one of the prize selection choices is sponsored by a marketer of a product or service and is presented as a fully integrated and branded experience by the marketer;
(d) launching the interaction mode for at least the first user and the one additional user;
(e) awarding the prize to one of the users of the interaction mode; and
(f) storing information about each user's participation in one or more of the interaction modes.

21. A computerized method for forming an online interaction mode comprising:
(a) providing at least one user interface over a network, wherein the user interface allows for interaction with a marketer of a good or service;
(b) receiving at least one prize selection choice from the marketer over the network via the at least one user interface;
(c) receiving at least one interaction mode selection choice from the marketer over the network via the at least one user interface;
(d) receiving at least one parameter relating to the interaction mode from the marketer over the network via the at least one user interface;
(e) receiving marketing options from the marketer over the network, wherein the marketing options brand an interactive experience; and
(f) developing the interactive experience as an online interaction mode for the marketer using the information from steps (b) through (e).
